(19) United States
(12) Patent Application Publication
(10) Pub. No.: US 2005/0261557 A1
(43) Pub. Date: Nov. 24, 2005

(54) Computer-based method and apparatus for evaluation of sensory and physiological parameters

(76) Inventor: Ernest W. Baker, San Francisco, CA (US)

Correspondence Address: JOHNSON & STAINBROOK LLP;Suite 203, 3558 Round Barn Blvd., Santa Rosa, CA, 95403, US

(21) Appl. No.: 10/847,730

(22) Filed: May 18, 2004

(51) Int. Cl. G06F 17/60

(52) U.S. Cl. 600/300; 705/2; 600/306

(57) ABSTRACT

A multi-part system of hardware and software for the evaluation of sensory and physiological parameters on a computer or over the Internet. The hardware/software suite may include three components, for the evaluation of visual field, auditory functioning, and heart/cardiovascular and autonomic nervous system (ANS) parameters.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

This invention relates generally to health screening and medical diagnostics, and more specifically to an improved method and apparatus for the evaluation of sensory and physiological parameters.

### BACKGROUND INFORMATION AND DISCUSSION OF RELATED ART

Some healthcare deficiencies are not adequately addressed by existing technologies, such as preventative health screening for detection of learning deficiencies and screening for underserved populations. For example, early healthcare screening in schools is currently inadequate because it requires costly methods utilizing multiple health professionals. Legislation has just instituted nationwide testing in all public schools to monitor students' academic performance, but no provision has yet been made for screening of physiological functions relevant to learning deficiencies.

Appropriate health screening is so crucial that experts recommend the following annual screening tests: birth to 10 years: cardiovascular, visual, and auditory; 11-64 years: cardiovascular and visual; and 64 years plus: cardiovascular, visual, and auditory.

The foregoing discussion reflects the current state of the art of which the present inventor is aware. Reference to, and discussion of, this information is intended to aid in discharging Applicant's acknowledged duty of candor in disclosing information that may be relevant to the examination of claims to the present invention. However, it is respectfully submitted that none of the prior art references disclose, teach, suggest, show, or otherwise render obvious, either singly or when considered in combination, the invention described and claimed herein.

### BRIEF SUMMARY OF THE INVENTION

The invention provides a multi-part system of hardware and software for the evaluation of sensory and physiological parameters using a stand-alone computer and/or over the Internet. The invention allows clinicians, educators, or home-users to gather key data related to physiological and psychological well-being, and to the preliminary evaluation of physical and emotional conditions. Applications of the invention include the evaluation of stress levels prior to therapeutic intervention, the monitoring of a patient's response to treatment or therapy, and the enhancement of learning potential. The user may keep the collected data stored on the user's own computer hard drive, or have the data gathered, stored, and managed in a central computer database, or have the data transferred to a third party such as a hospital or health maintenance organization, all through the use of computer network and data transfer technology well known in the art.

The hardware/software suite may include three components, for the evaluation of visual field, auditory functioning, and heart/cardiovascular and autonomic nervous system (ANS) parameters. The visual field screening component consists of interactive software for the measurement of a range of visual parameters, including binocularity, color blindness, contrast sensitivity, and blindspot size. This software is accompanied by a hardware component consisting of a stand allowing for support and stability of the head while undergoing evaluation, and for the covering of each eye in turn. The auditory component includes software for testing auditory functioning (e.g., detection of sound frequencies) plus hardware consisting of simple earphones to be plugged into the computer. The heart and ANS component of the suite comprises a device to be strapped or otherwise applied to the body (e.g., a device strapped onto the finger, or affixed to the ear) and plugged into the computer, plus software that reads and interprets physiological parameters from the device. These parameters may include a range of data of relevance to heart and ANS functioning, including pulse rate, heart rate variability, and galvanic skin response.

The inventive concept can be utilized in both business to business operation, for example use by an Internet health or education portal for use with their customers, and a business to consumer version, by which common users of the Internet can monitor themselves or their families for physiological or neuro-sensory measurements. The individual user or organization may configure the Internet application by means of age, gender, or according to special needs (e.g., sports enhancement or educational enhancement). The Internet application may be used to print a report for the user, send a report to their health or educational professional, or store in an online database for future reference or comparison.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic view of an apparatus of this invention, illustrating a stand for head support while undergoing visual parameter evaluation, with integral auditory and heart/ANS components or connections therefor; and

FIG. 2 is a schematic view of an auditory functioning evaluation apparatus of this invention, the visual and heart/ANS hardware being configured in a similar manner.

### DETAILED DESCRIPTION OF THE INVENTION

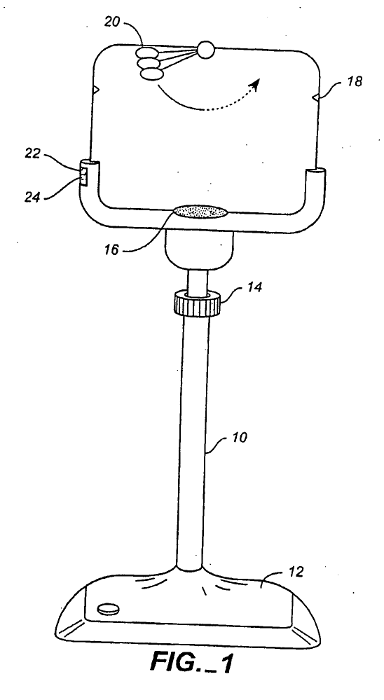

FIG. 1 is a schematic view of an apparatus of this invention, illustrating a stand 10 for support and stability of a user's head while undergoing visual parameter evaluation, and to keep the user's head the correct distance from the monitor or screen. Support 10 may include a base 12, an adjustable-height shaft 14, and a chin rest 16. Eye-mask 18 and lenses 20 may be used in the visual parameter evaluation. Audio connection 22 may be used to interconnect the headphones and computer/CPU (not illustrated). A heart/ANS sensor 24 may be integral to the stand 10, or merely be connected to the computer/CPU via the stand for convenience.

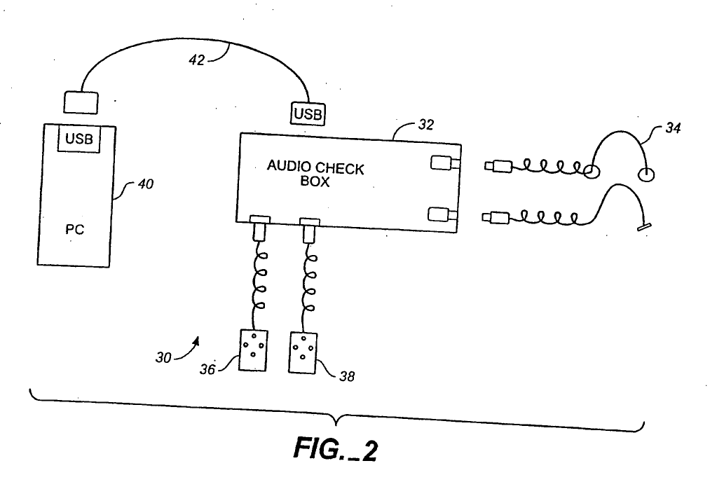

FIG. 2 is a schematic view of an auditory functioning evaluation apparatus 30 of this invention. Apparatus 30 may include an audio control box 32 interconnecting headphones 34 with practitioner control 36 and patient control 38. Audio control 32 may be connected to computer/CPU 40 by USB connector 42 or other means. The visual field and heart/ANS hardware may be configured and connected to the computer in a similar manner.

The inventive apparatus includes three technologies that are already used in stand-alone applications for detection of health risks. For the first time, by bundling two or more of these components by computer and/or utilizing the Internet, the invention provides a cost-effective and broad health screening and reporting system. The monitoring components are:

Visual Field—evaluates a number of key visual functions that may relate to diabetic retinopathy, macular degeneration, color discrimination, phoria, contrast sensitivity, eye motility and other ocular conditions.

Auditory Functioning—assesses hearing performance by utilizing multiple sophisticated auditory testing methods.

Heart and ANS—monitors several predictive cardiovascular and autonomic nervous system parameters which may be associated with attention deficit disorder, depression, hypertension and stress.

The suite's hardware package consists of three inexpensive devices: (1) a chin rest with an eye patch for visual field testing, (2) earphones for auditory functioning, and (3) an infrared sensor for heart and ANS parameters.

This three-part, health-monitoring suite provides reproducible data that is predictive of clinical events and offers early interventional value. It can provide early detection of several disease processes, monitor some pharmaceutical side effects and assist in chronic disease management. These interactive screening tools provide user-friendly, non-invasive, physiological measurements. Clinicians and educators can collect this data on any Internet-enabled computer. The results of these tests can be sent to selected specialists via the Web for further analysis.

Privacy issues are addressed in accordance with the need for patient record privacy standards. To that end, coding such as password and zip code, rather than name, address or phone number, can secure all personal data. Healthcare and educational professionals have the option of storing data on their hard drives or having the data transferred and managed by a third party.

The invention's Internet enabled monitoring suite retools healthcare screening tasks (historically performed only by physicians and costly specialists in centralized inconvenient locations) by using computer advances and the Internet to accomplish these tasks at much lower cost to both practitioner and client.

The invention allows for the analysis of interactions between various physiological systems. Analysis of such interactions may offer an early warning for particular disabilities. For example, policemen often have hearing and/or visual problems associated with job-related stress; early Alzheimer's disease patients often have eye tracking and autonomic nervous system maladies; and poor heart rate variability can be associated with diminished central field vision and/or diabetes.

The requisite hardware is inexpensive and can be used repeatedly by one or more people. Some tests require no hardware, or use components that most practitioners already possess.

Practitioners may choose combinations of monitoring components as well as subcomponents that are appropriate for a defined setting (e.g., industrial, educational, medical, psychological settings). Similarly, users will be able to configure the monitoring suite according to age, gender or special need (e.g., sports skills, stress monitoring and management).

The evaluation of visual field may be accomplished by an available program such as EnVision by Interactive Medical Systems, available from Biotechtronics of San Francisco, Calif. This program is a comprehensive and innovative suite of vision screening tools available for IBM-compatible personal computers running Microsoft Windows operating systems. The vision screeners can be run in either a stationary office or portable field environment. They are ideal for nursing homes, health fairs, schools, in-field use, clinical studies, home monitoring, hospitals and as fast screening tools for the optometrist's, ophthalmologist's or even pediatrician's office.

All screeners may include a simple Patient Manager for storing and tracking patient data, and may further include screeners for the following areas:
Static Acuity for near and far (e.g., Sloan-like letters, tumbling E's and pictographs);
Binocularity (vertical and horizontal phorias, Vergences)
Central Field Distortion (Customizable Amsler-like grids with on-screen notation);
Color Blindness/Deficiency (Pseudoisochromatic plates and Farmsworth D15-like);
Central Kinetic Fields and Blindspot Mapping (tangent screen-like screener);
Contrast Sensitivity (Grayscale and Color Contrast screening);
Dynamic Acuity (Moving letters/figures);
Ocular Motility (Saccades and Pursuits); and
Accommodation (Standard tables).

The screeners are controlled using simple icons and pulldown menus. They were designed to be easy to use and are fully parameterized allowing the user complete control over all aspects of operation. Each screener can be run in a simple automatic mode or can be run manually. Automatic mode runs a complete screening with instruction prompts. Manual mode allows the user to run any portion of a screening (say the left eye only) with full control over all aspects of the program such as color settings, display options, etc. Manual mode allows the screeners to be run very quickly for those situations where screening time is of great concern. A full set of Windows HELP menus with graphics are available for all aspects of the program. A consistent user interface is provided for all screeners.

The screeners can either be administered by the eye doctor or an assistant, or if desired, can be self-administered with little direction. Thus, under proper medical supervision the screeners can be used for in-home monitoring of degenerative conditions.

EnVision consists of a main menu which is used to activate the individual screeners and the system functions included in all versions: Patient Manager, Monitor Configuration, and Help.

Static Acuity: Near (24 inches) and Far (10 feet) acuities are included using Sloan-like letters. For fine near acuity screening (beneath 20/40), a pattern matching technique is used because computer fonts can not be accurately be displayed for letters that small. The 24″ and 10′ distances were chosen to obtain optimum computer screening for acuity.

The Central Field Distortion Screener uses Amsler-like grids and a number of other charting techniques (dots, diagonals, combinations) to determine any central field distortions or scoromas. You can easily notate Macular degeneration patterns on the screen with the mouse.

The color deficiency screener is a D15-like color test representing the most sophisticated screener available for the P.C. In addition to performing standard color screening, customized color screening palettes can easily be created using the innovative color tools included with each color screening package. This turns the color screener into a versatile utility capable of screening for specialized color problems. For example, if you find a green color deficiency, you can easily create a customized color palette to see where in the green spectrum the problem is most pronounced.

All versions of the vision screeners include a simple Patient Manage database to store pertinent patient records and screening results for future reference and comparison with new screenings.

Contrast sensitivity provides extremely affordable grayscale and color contrast sensitivity screening.

Envision has a number of functions:

1. Static visual acuity: lets the individual or group determine the acuity of those being screened and allows for monitoring of changes. This is most useful with children and seniors.

2. Binocular screening: this gives information on people with learning disabilities, head injury, sports deficits and stroke patients. This screener gives information on the ability of the fixation system to either hold target or move through space in an appropriate speed and time.

3. Central visual fields: or amsler grid. This test is of value to anyone monitoring a central visual loss or distortion. It is also of value to those patients at risk for central field loss due to retinal hemorrhage from macular degeneration, diabetic retinopathy, or central holes as well as many other macular diseases.

4. Color blindtest: this test is the most sensitive color test available short of the 100 dot test that is only used in research. It is valuable in screening for color deficiencies in jobs as well as in sensitivities to certain medications.

5. Central kenetic fields: visual fields are of assistance in picking up field loss after a stroke or closed head injury. Some studies suggest that depression and anxiety can be diagnosed by field studies. Differentiation of field loss verses neglect can be found and stress induced field loss can be found. Blind spot studies can show a number of diseases although my device is not sensitive at this point to be used to measure these diseases. Syntonic use is fine.

6. Ocular motilities: tracking problems can be detected in learning disabilities and head injury. Studies have shown early tracking deficits exist in Alzheimer's disease and other neurological deficits that occur in seniors predominantly.

7. Accommodation: this area of deficit frequently shows up in head injury especially in the young, learning disabilities, and ocular repetitive stress syndrome (ORSS) that happens after hours on the computer.

8. Dynamic acuity: this is a screener for athletes.

9. Contrast sensitivity: this is a screener that gives information on the quality of vision in closed head injury, cataracts, multiple sclerosis, for glare problems, and a number of other neuro visual dysfunctions.

Audio functioning evaluation may be accomplished by AudioVision, audiophonology technology available from Biotechtronics of San Francisco, Calif. AudioVision includes a system that enables the administration of a hearing test that makes it possible to measure the entire range of frequency response of the ear divided into octaves. The client can establish the range of frequency responses for the hearing test on his own. Verification is carried out automatically. Once the session is over, the hearing test is stored in a database.

The 54 frequencies generated are part of the series of octave ninths based on the note “C” from 32 HZ to 16384 HZ. The choice of these frequencies spread over 9 octaves enable the performance of classic or elaborate hearing tests. The frequencies used can be chosen from a configuration menu: Hearing tests by octaves; ½ octaves; ⅓ octaves; and 1/16 octaves; classic hearing test using frequencies 128-256-512-724-1024-1448-2048-2896-4096-5793-8192-11585; and special audiometry programs.

Features include Automatic Audiometry, in which testing begins with the lowest frequencies and ends with the highest. The client controls the sound level with a joy-stick and presses a signal button when she reaches the limit of her perception. In Semi-Automatic Audiometry, the audiometry is controlled by two joy-sticks, one for a therapist/operator, the other for the client. The sound is constant, pulsating, or of modulated amplitude. In Manual Audiometry, the testing and sound levels are entirely controlled by therapist/operator.

Heart and ANS evaluation may be accomplished by the CardioVision program by Biocommunications, Inc., and available from Biotechtronics of San Francisco, Calif. The program's Heart Rate Variability Analysis System is a clinical toolbox that offers physicians and health care practitioners a convenient system to develop protocols and measure results using sophisticated heart rate variability analyses. The system employs the advanced technology of a software platform that allows for continuous monitoring and measuring of “real time” physiological signals. It is a non-evasive, intuitive, easy to use software and hardware system that monitors and measures heart rate variability. Heart rate variability (HRV) and heart rate are important measures that open a window in the status of the human organism providing precise information about autonomic nervous system functioning. The software is dynamic and operates through “plug and play” Electro cardiographic (ECG) or Photoplethesmographic (PPG) technologies.

Heart rate variability measures the hearts reaction to any type of stress. When heart rate is analyzed by frequency and time analyses several important characteristics emerge. One component, Respiratory Sinus Arrhythmia (RSA) is strongly controlled by the parasympathetic system and is mediated by respiration. Parasympathetic activity normally has a short response time (2 to 5 seconds) and can therefore be observed in a narrow band of heart rate variations in a high frequency range. Both sympathetic and parasympathetic activity are reflected in the medium frequency of HRV (7 to 15 seconds), and predominant sympathetic activity (>20 seconds) is reflected in the very low frequency range. When analyzed mathematically these variables represent a quantitative multidimensional measure of autonomic activity and cardiac function. The invention includes a complete system that measures and monitors these parameters.

Positive changes in overall heart rate variability (increases) have been linked by a number of studies to improvement of physical and psychological symptoms. The role of heart rate variability in cardiovascular disease, SIDS, depression, sudden cardiac death, chemical dependency, overall longevity, anorexia nervosa, diabetes, and anxiety/panic has expanded understanding of these maladies. This new information allows development of more effective interventions, assists physicians and health care practitioners quantitatively determine whether their treatments are efficacious, and provides a new measure of vital functioning. The invention provides data that is critical for predicting and preventing future autonomic nervous system and cardiac dysfunction.

The heart and ANS evaluation may further include analysis of APG (Acceleration PlethysmoGram), which is the second derivative of PTG (Plethysmogram). The pulse wave is the change of pressure originated from the heart beat and transmitted through a vessel. The pulse wave is changed under the power of systole or the state of circulation (the main artery, the artery, a capillary), and reflects the state of blood circulation. Analysis of the results of the measurement is facilitated by showing more divided wave patterns. From the APG wave, some or all of the following can be evaluated: cardiac intensity, elasticity of the blood vessel, amount of remaining blood, elasticity of the vessel wall, aging of the vessel, relation of cardiac output, hypertension, arteriosclerosis, cardiac faculty, arrhythmia, heart failure, cardiac output, autonomic nervous disorder, and effect of cardio tonic or other remedies and various stimulus.

Features include: complete freedom to develop individualized protocols, quickly and conveniently; real time measurement of heart rate variability; power spectral density analysis to distinguish the regulated interaction of the sympathetic and parasympathetic system; precise and understandable trial-based readouts of heart rate variability; very low, low and high frequency scores and ratios; bar graphs and spectral analyses that depict balance or imbalance of autonomic nervous system; accurate online spectral analysis of heart rate by tachogram; accurate readout of beats per minute and interbeat intervals; analytic reports including graphs, tables and narratives; Windows format for colorful graphics and display screens and ease of use; easy installation with plug and play technology; and galvanic skin response monitoring.

Accordingly, the invention may be characterized as a software-based health screening and reporting system (apparatus) with one or more of visual field screening, auditory function screening, and heart and autonomic nervous system parameters screening, where results from the screening(s) may be processed by a stand-alone computer (which may have been loaded with the software directly or downloaded the software from a global computer network) and/or delivered to a remote facility via a global computer network. Alternatively, the invention may be characterized as a method for health screening and reporting comprising the steps of providing means for one or more of visual field screening, auditory function screening, and heart and autonomic nervous system parameters screening, and processing the data on a stand-alone computer and/or delivering results from the screening(s) to a remote facility via a global computer network.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A software-based health screening and reporting system, said system comprising:
screening means selected from the group consisting of visual field screening, auditory function screening, and heart and autonomic nervous system parameters screening, wherein results from said screening are processed by a computer.

2. The health screening and reporting system of claim 1 wherein said results from said screening are delivered to a remote facility via a global computer network.

3. The health screening and reporting system of claim 1 wherein said means for visual field screening comprises means for measurement of a plurality of visual parameters.

4. The health screening and reporting system of claim 3 wherein said visual parameters comprise binocularity.

5. The health screening and reporting system of claim 3 wherein said visual parameters comprise color blindness.

6. The health screening and reporting system of claim 3 wherein said visual parameters comprise contrast sensitivity.

7. The health screening and reporting system of claim 3 wherein said visual parameters comprise blindspot size.

8. The health screening and reporting system of claim 1 wherein said means for auditory function screening comprises means for testing detection of sound frequencies.

9. The health screening and reporting system of claim 1 wherein said heart and autonomic nervous system parameters comprise pulse rate.

10. The health screening and reporting system of claim 1 wherein said heart and autonomic nervous system parameters comprise heart rate variability.

11. The health screening and reporting system of claim 1 wherein said heart and autonomic nervous system parameters comprise APG.

12. The health screening and reporting system of claim 1 wherein said heart and autonomic nervous system parameters comprise galvanic skin response.

13. The health screening and reporting system of claim 1 wherein said heart autonomic nervous system parameters are diagnostic and predictive of ATHD.

14. The health screening and reporting system of claim 1 wherein said heart and autonomic nervous system parameters are diagnostic and predictive of depression.

15. The health screening and reporting system of claim 1 wherein said heart and autonomic nervous system parameters are diagnostic and predictive of hypertension.

16. The health screening and reporting system of claim 1 wherein said heart and autonomic nervous system parameters are diagnostic and predictive of stress.

17. A method for health screening and reporting, said method comprising the steps of:
Providing means for visual field screening;
Providing means for auditory function screening;
Providing means for heart and autonomic nervous system parameters screening; and
Delivering results from said screening to a remote facility via a global computer network.
